(19) United States
(12) Patent Application Publication
(10) Pub. No.: US 2025/0183561 A1
(43) Pub. Date: Jun. 5, 2025

(54) Connection terminal for conductors

(71) Applicant: Weidmüller Interface GmbH & Co. KG, Detmold (DE)

(72) Inventors: Till SCHMITZ, Detmold (DE); Peter STUCKMANN, Lage (DE)

(21) Appl. No.: 18/962,079

(22) Filed: Nov. 27, 2024

(30) Foreign Application Priority Data
Nov. 30, 2023 (DE) 102023133525.1

(51) Int. Cl. H01R 4/48; H01R 9/26

(52) U.S. Cl. CPC H01R 4/483; H01R 9/2616

(57) ABSTRACT

A connection terminal for connecting a conductor is formed as a direct plug-in terminal with a clamping spring arranged in a housing with a resilient clamping leg which can move into an open position and into a locking position. There is provided an actuating device to press down the clamping leg into the open and locking positions for the insertion of a conductor. The housing has a conductor insertion channel for insertion of the conductor into a clamping point between a free end of the clamping leg and a busbar. The actuation device furthermore has a pressing element and a pivoting element which interacts with the pressing element at least when the clamping leg moves into the locking position. At least one releasing mechanism is provided to release the locking state of the clamping leg of the clamping spring. The pivoting element is formed to act on the pressing element and the pressing element is formed to act on the clamping spring, in particular the clamping leg. Wherein the pivoting element, when pivoting after the clamping leg is locked in the locking state, can be moved further up into a stop position, in which it comes to bear on a counter-stop.

### BACKGROUND

The invention relates to a connection terminal for conductors, and more particularly for a conductor formed as a direct plug-in terminal.

It is known from DE 102004001202A1 that a clamping spring locked in an open state from the locking position can be released with a pivoting lever so that the clamping spring can relax and press a conductor, which can be inserted into a clamping point, against a busbar to contact the conductor end. Restoring the locking state can be carried out with a screwdriver. It is also known from DE 3019149A1 that direct plug-in terminals can be released from the locking position with a clamping spring that is locked in an open state with a conductor end so that the clamping spring can relax in order to contact the conductor end. Restoring the locking state can take place with a pivoting element, which is arranged externally on the clamping housing.

From WO 2017/207429A2, it is further known that a direct plug-in terminal can be released from a locking state via a clamping spring with two different adjustment mechanism, wherein one of the adjustment mechanism is a rocker that can be actuated via a free conductor end and the other adjustment mechanism is a pressing element. Restoring the locking state takes place with the pressing element. DE 102020123188A1 discloses a connection terminal in which an actuating device has a pressing element and a pivoting element which interacts with the pressing element at least when the clamping leg is being moved into the locking position. At least one releasing mechanism is provided for releasing a locking state of the clamping leg of the clamping spring. The releasing mechanism is designed in such a way that the locking position can be released again by the action of the conductor on the releasing mechanism when it is inserted. The pivoting element is formed to act on the pressing element and the pressing element is formed to act on the clamping leg.

There is however a need to create a connection terminal that has been further developed in terms of reliable functionality.

### SUMMARY OF THE INVENTION

Accordingly, it is an object of the present disclosure to provide a connection terminal for connecting a conductor that is formed as a direct plug-in terminal. The connection terminal includes a clamping spring arranged in a housing with a resilient clamping leg, which can move into an open position and into a locking position. There is provided an actuating device to press down the clamping leg into the open and locking positions for the insertion of a conductor. The housing has a conductor insertion channel for insertion of the conductor into a clamping point between a free end of the clamping leg and a busbar. The actuation device furthermore has a pressing element and a pivoting element which interacts with the pressing element at least when the clamping leg moves into the locking position. At least one releasing mechanism is provided to release the locking state of the clamping leg of the clamping spring. The pivoting element is formed to act on the pressing element and the pressing element is formed to act on the clamping spring, in particular the clamping leg. Wherein the pivoting element, when pivoting after the clamping leg is locked in the locking state, can be moved further up into a stop position, in which it comes to bear on a counter-stop.

Preferably, when the pivoting element pivots after the clamping leg is locked in the locking state, it can be moved further up into a stop position, in which it comes to bear on a counter-stop.

In this manner, it is possible to safely prevent the user (usually an electrician or electronics technician) from pivoting the pivoting lever too far beyond the required position when releasing the locking state. This prevents the connection terminal or the pivoting lever from being damaged, as the pivoting lever is stopped safely and in a defined manner in a stop position.

In one embodiment, the pivoting angle alpha for reaching the locking position is preferably 60°-90° from the initial starting position of the pivoting element, which is advantageous for realizing defined and easily perceptible and recognisable movements of the pivoting element. However, it can also have a different value.

Preferably, the locking position can be released at least by the conductor acting on the releasing mechanism when it is inserted.

According to another embodiment, it can be envisaged that the stop on the pivoting element and the counter-stop are formed as corresponding stop and counter-stop surfaces, which lie oriented parallel or substantially parallel to each other in the stop position after covering the predetermined pivoting angle alpha. In this way, a secure stop position can be easily perceived by the user and simply realized.

To ensure good functionality of the respective spring clamp, the pivoting element is preferably arranged in front of the pressing element, in the actuation channel, in the conductor insertion direction. the pivoting element may also or alternatively be formed as a pivoting lever, which is pivotably mounted in or on the housing and has a pressing arm with which it acts on a corresponding pressing surface of the pressing element via a pressing contour. It also has an actuating arm, which is preferably used for manual actuation of the pivoting lever.

According to further advantageous optional embodiments, it is preferable for the stop surface of the pivoting element to be provided on the pressing arm of the pivoting element formed as a pivoting lever. The corresponding stop surface can then be provided either on the pressing element or on the housing, as an example.

According to another embodiment, the pressing element is linearly or substantially linearly movable in an actuation channel of the housing. It is expedient, but not absolutely necessary, for the actuation channel to run parallel to the conductor insertion channel.

Additionally, the pressing element itself can be locked in the locking position, to preferably hold the clamping leg in the open position for insertion of the conductor.

However, in an alternative embodiment, a locking spring, which serves to lock the clamping spring in an open locking state in a releasable manner, can be advantageously and simply formed on the clamping spring.

In yet another embodiment, the pivoting element is arranged in the actuation channel in front of the pressing element in the conductor insertion direction. This arrangement is particularly advantageous, but not mandatory. Alternatively, the pivoting element can be arranged in the actuation channel behind or beside the pressing element in the conductor insertion direction.

In further embodiments, the pivoting element is pivotably mounted on the housing with a pivot bearing with a fixed axis of rotation. Alternatively, the pivoting element can be pivotably mounted on the housing with a pivot bearing with an axis of rotation that moves in a translatory manner (in one to three spatial directions in succession or simultaneously) in space when the pivoting element is pivoted. In this way, notably the space requirement of the pivoting element during the rotary movement can be optimized in accordance with the respective installation space dimensions.

The conductor, when being inserted into the conductor insertion channel, can act on a first releasing mechanism for releasing the locking position of the clamping spring.

Optionally, one or more further releasing mechanism can be realized.

According to a further advantageous configuration, the pivoting element is arranged completely or partially in the actuation channel, in particular, pivotably mounted in the actuation channel.

In this case, according to advantageous variants, the pressing arm rests freely on the actuating element without coupling so that the pivoting lever can press the clamping spring or the clamping element and the pressing element into an open and locking position via the pressing element. Preferably, the pivoting element can be pivoted back out of the stop position without the pressing element.

In an alternative embodiment, the pivoting lever is coupled to the pressing element via a coupling device.

In yet another embodiment, the pivoting element and/or the pressing element are formed as an optical indication element, from the position of which it is possible to see whether the clamping leg of the clamping spring is in the open or in the clamping state.

It is further an object of the present disclosure to provide a terminal block having one or more connection terminals according to those described above. It is also an object to provide a plug connector or a printed circuit board terminal having one or more connection terminals according to those described above, wherein the plug connector or printed circuit board preferably have a disc-like structure.

### BRIEF DESCRIPTION OF THE DRAWINGS

The invention is described hereinafter with reference to the drawings. It should be emphasised that only preferred exemplary embodiments are described, to which the scope of protection is not limited. Rather, variations and equivalents of the exemplary embodiments depicted can also be realized. In the drawings:

FIG. 1a is a perspective view of a plug-in connector disc for a plug-in connector with two connection terminals formed as direct plug-in terminals in a clamping position in which they could each fix a conductor in a contact position contacting a busbar;

FIG. 1b is a front view of the plug-in connector disc from FIG. 1a;

FIG. 1c is a partial enlarged view of detail “D” from FIG. 1b;

FIG. 2a is a perspective view of two strung-together plug-in connector discs each having a connection terminal formed as direct plug-in terminals wherein the front plug-in connector disc or its terminal device is in a locking position in which a conductor would be insertable into the opened clamping point, a pivoting lever is moved into a stop position on a pressing element, and the pivoting lever of the terminal device of other plug-in connector disc is in a bearing position on the housing;

FIG. 2b is a plan view of the discs from FIG. 2a;

FIG. 2c a front view of a plug-in connector disc from 2a; and

FIG. 2d is a partial enlarged view of detail “E” from FIG. 2c;

FIGS. 3a-3e are partial front, front, perspective, front and perspective views, respectively, of the plug-in connector disc from FIG. 1a showing the pivoting lever being moved in two angle steps from a first starting position, such as a bearing position on the housing, into a stop position on a pressing element;

FIGS. 4a-4e are partial front, perspective, front, perspective and front views, respectively, of the plug-in connector disc from FIGS. 1a and 3a-3e showing the pivoting lever being moved in two angle steps from a first bearing position on the housing into the stop position on the pressing element;

FIGS. 5a and 5c are perspective and side views of an actuation device of the plug-in connector disc from FIG. 1a, wherein the pivoting element is not entirely resting on the housing of the plug-in connector;

FIGS. 5b and 5d are perspective and side views of an actuation device of the plug-in connector disc from FIG. 1a, wherein the pivoting element has been moved into a stop position in a pivoted-out state;

FIGS. 6a-6d are cross-sectional partial views of the actuation device of FIGS. 5a and 5c along the lines A-A (also shown in FIG. 2b);

FIG. 7a is a perspective view of a further plug-in connector which is composed of a number of plug-in connector discs each having two connection terminals which are formed as direct plug-in terminals and which show one pivoting lever;

FIG. 7b is a perspective view of the plug-in connector of FIG. 7a with one of the plug-in connector discs released from the row;

FIG. 7c is a perspective view of the plug-in connector from FIG. 7b with the plug-in connector disc further from the remaining plug-in connector discs;

FIGS. 8a and 8b are partial perspective views of a section of the plug-in connector from FIGS. 7a and 7b which is composed of a number of plug-in connector discs, wherein the pivoting levers of the connection terminals have been pivoted into different rotational positions;

FIG. 9a is a perspective view of the arrangement from FIG. 8b; and

FIGS. 9b and 9c are partial cross-sectional views of FIG. 9a through a section of the plug-in connector disc, which is the third from the front in FIG. 9a.

### DETAILED DESCRIPTION

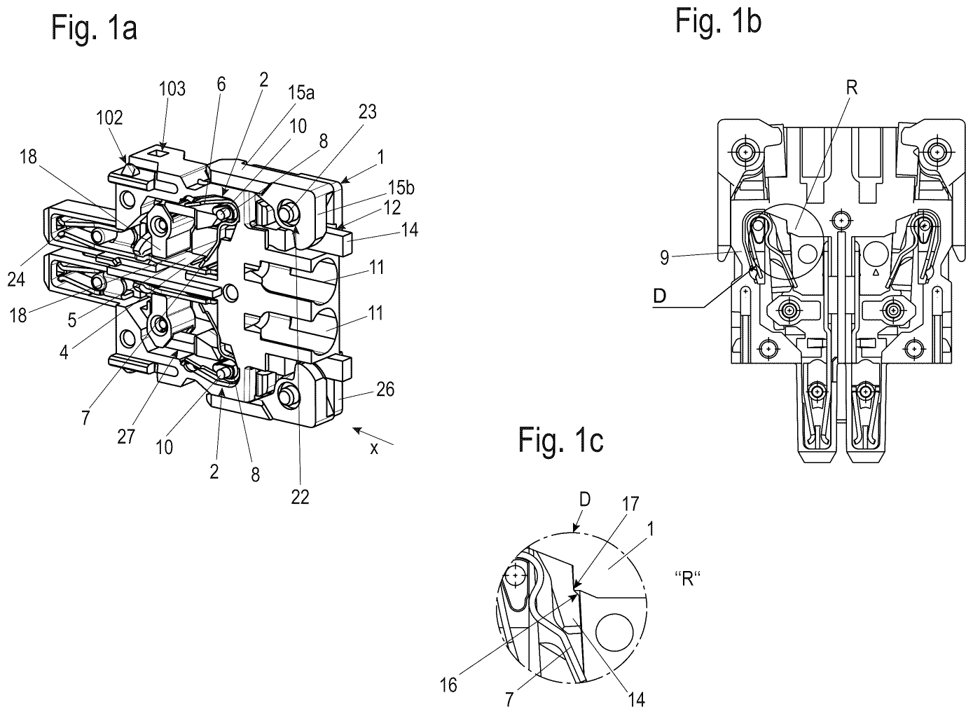

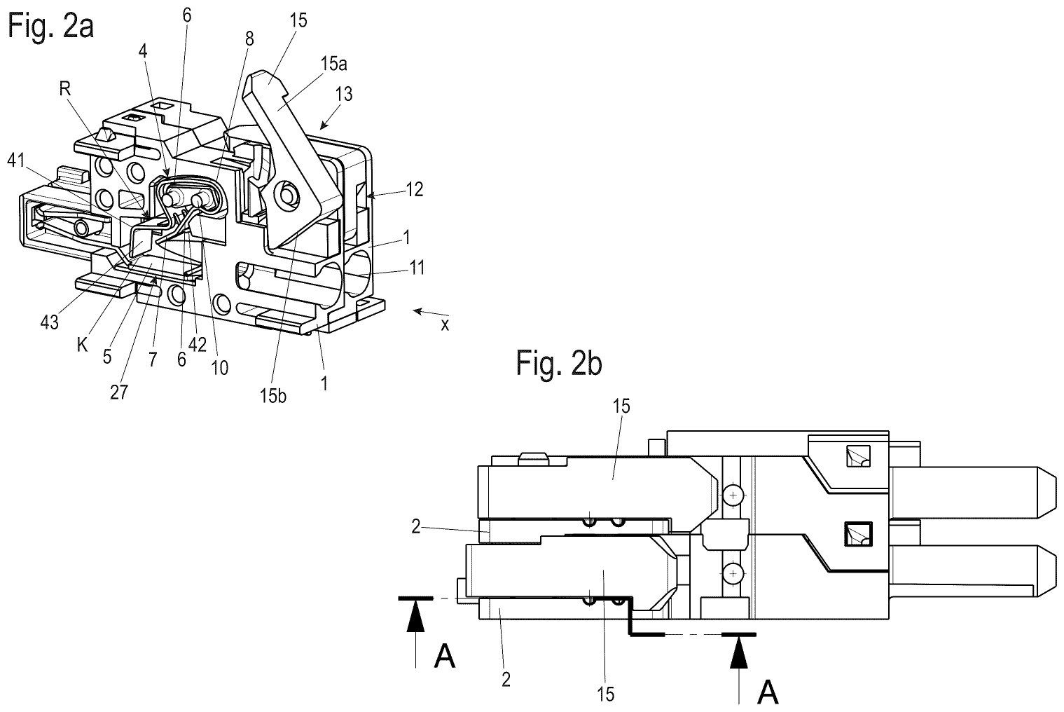

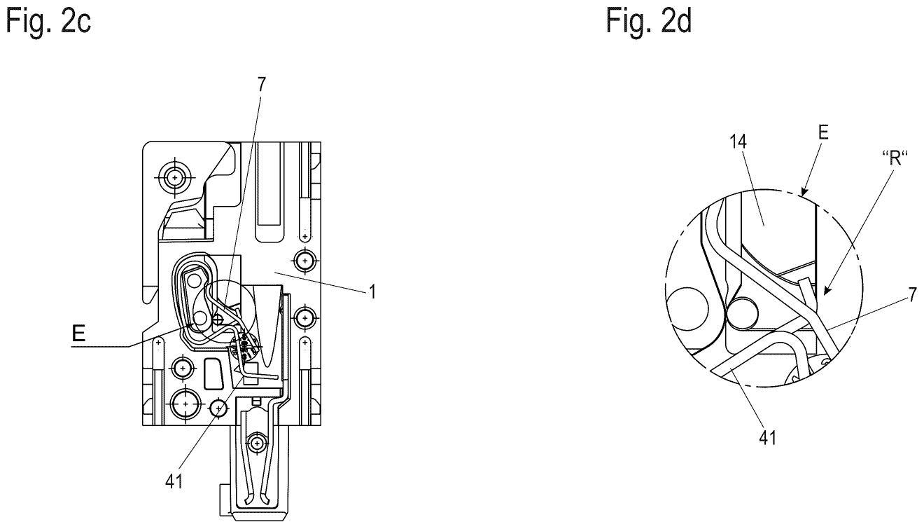

FIGS. 1a and 2a show one and two plug-in connector discs, respectively, each having a housing 1. As can be seen in FIG. 2a, two or more plug-in connector discs can be strung together, in particular directly next to each other.

The housing 1 is of a plug-in connector disc that is preferably a multi-disc plug-in connector, in which one (FIG. 1a) or more (two in FIG. 2a) connection terminals 2 can be formed. The connection terminals 2 of FIG. 1a and FIG. 2a have a similar function with regard to creating a locking position, which is explained in detail below.

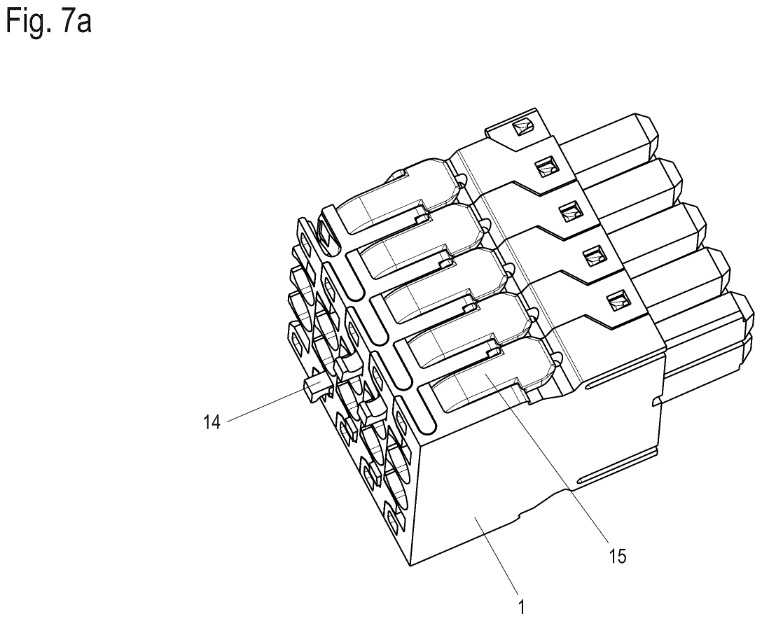

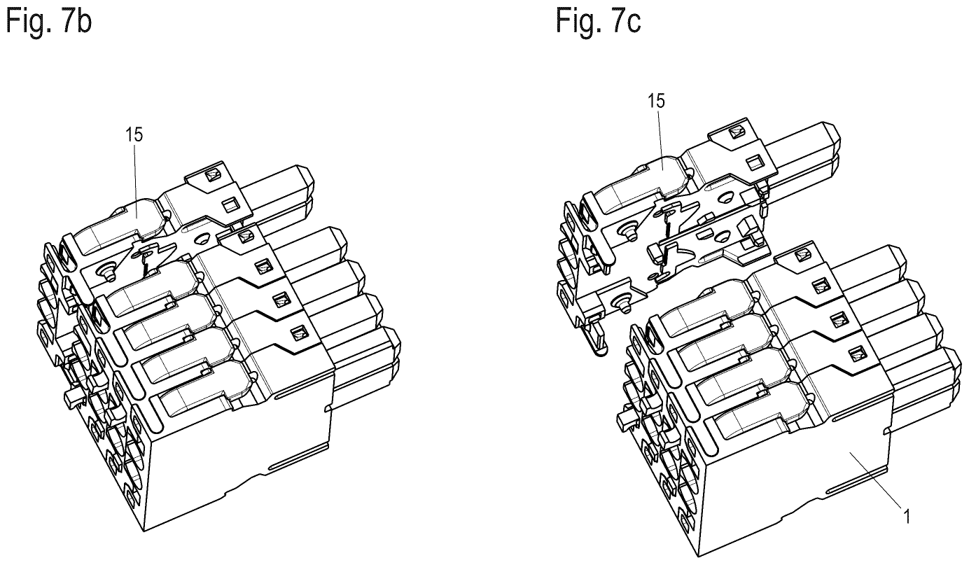

It is thus possible (see also FIG. 7a) to plug a number of plug-in connector discs—or rather their housings 1—onto one another in a stringing-together direction, and thus to produce a plug-in connector arrangement in a disc design. The individual plug-in connector discs can then be assembled with corresponding locking and/or clamping mechanisms, such as locking mechanism 102 and counter-locking mechanism 103 showing in FIG. 1a, to form a higher-level plug-in connector.

The housing 1 could alternatively be formed as the housing 1 of another apparatus, such as the housing 1 of a terminal block or the like (not shown here), which would then have one or more of the connection terminals 2.

The respective connection terminal 2 is suitable or designed for connecting a free conductor end of a conductor (not depicted here), for example a conductor which is stripped in the end region.

The structure of one of the connection terminals 2, with multiple preferably having the same configuration, is described in greater detail below. Two connection terminals 2 could also be structured differently, for example one connection terminal 2 could be designed as a direct plug-in terminal of the type depicted and the other as a connection terminal of a different design.

The connection terminals 2 shown in the figures have a clamping spring 4 and a busbar 5. The clamping spring 4 can be used to press a free—e.g. stripped—conductor end of a solid or stranded conductor against the busbar 5, to conductively connect the conductor end and the busbar 5 to one another. This position, which is depicted on the left-hand connection terminal 2 in FIG. 1a without a conductor end being inserted into it, is also referred to hereafter as the clamping position or contact position K. The conductor, in a clamping state, is pressed onto the bus bar 5 and thus contacted. The busbar 5 can also be formed as part of a higher-level element such as a clamping cage.

The clamping spring 4 can be formed in a V shape or substantially in a V-shape. The clamping spring 4 has a supporting leg 6 for supporting the clamping spring 4 on an abutment, such as on a web 9 (FIG. 1b) of the housing 1, and a resiliently acting clamping leg 7. The two legs 6, 7 can be connected to one another via at least one arc 8. Near the arc 8, the clamping spring 4 can be placed over a journal 10, which is a journal 10 of the housing 1. A connection of the clamping spring to the busbar can thus be advantageously and simply dispensed with and support of the clamping spring 4 in the plastic of the housing 1 is durable and secure. Other types of support are conceivable.

Two channels 11, 12 are preferably formed in the housing 1 in sections to the side of the clamping spring 4, and preferably in sections above the clamping spring 4. The channels 11, 12 extend substantially or exactly parallel to a conductor insertion direction X.

One of the two channels 11, 12 is a conductor insertion channel 11, through which a conductor end can be guided in a conductor insertion direction X into the region of a clamping point or conductor contacting point K (see FIG. 2a) in the housing 1 in the region of the clamping spring 4 at the free end of the clamping leg 7. The precise location of the conductor contacting point depends on the conductor diameter.

The other of the two channels 11, 12 is an actuation channel 12 for moving an actuation device 13 of the connection terminal 2 in the housing 1.

The actuation device 13 includes a pressing element 14 with a pivoting element 15.

The pivoting element 15 can be a pivoting lever, which has two lever arms 15a, 15b arranged at an angle to one another. The lever arm 15a is an actuating arm and the lever arm 15b is a pressing arm (see FIG. 2a).

The pivoting element 15 is connected upstream of the pressing element 14 in the direction of the clamping spring 4. The pressing element 14 can be designed to act directly on the clamping leg 7 with the lever arm 15b, to move or pivot it into an open position and locking position. The actuating arm or the lever arm 15a can protrude externally out of the housing 1, so that it can be operated by hand.

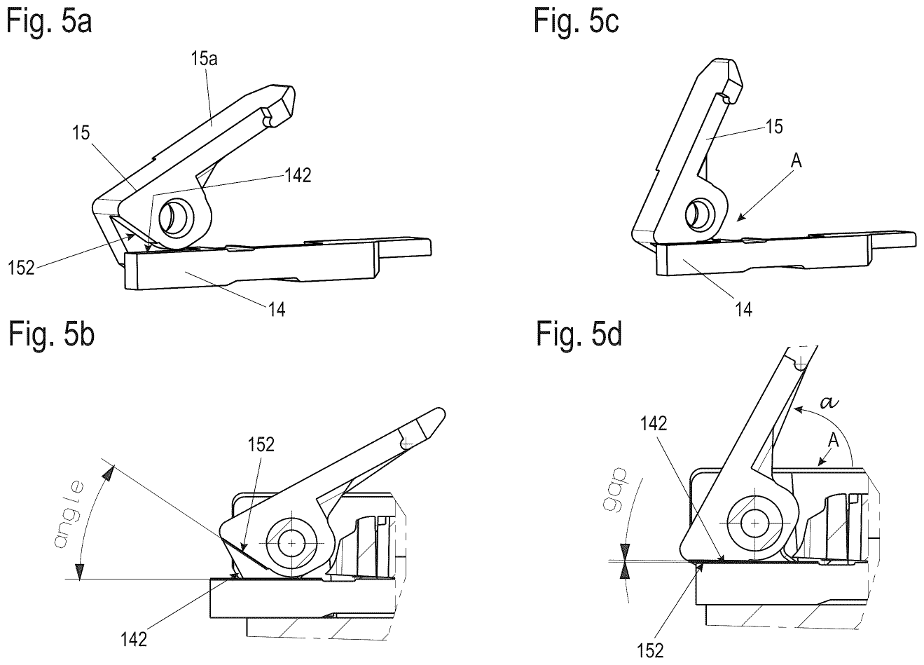

The pivoting element 15 acts on the clamping leg 7 via at least the pressing element 14. Preferably, the pressing element 14 and the pivoting element 15 are formed as separate structural parts. These can lie loosely against one another, so that they move together in the pressing direction or conductor insertion opening X and so that they can be separately removed from the region of the clamping point (see also FIGS. 5a-d).

However, the pivoting element 15 and the pressing element 14 can also be coupled to one another in such a way that they can only be moved jointly both in the conductor insertion direction X and counter to this direction (not depicted).

The pressing element 14 can be substantially formed as a sliding element that can be moved linearly or substantially linearly in the actuation channel 12, with which sliding element pressure can be exerted on the clamping leg 7 outside of its clamping edge to move it into an open position in which the clamping point K is open so that a conductor end can be inserted into it or between the free end of the clamping leg 7 and of the busbar 5. The pressing element 14 could also be moved in a predetermined position in the actuation channel 12 with a movement component at an angle to the conductor insertion direction and into a locking position R, in which it is locked in the housing 1 of the connection terminal 2 on a locking edge 17, on the busbar section 3, or the like. In this position, locked in the housing 1, it acts on the clamping leg 7 to press it down so that a contacted conductor can be removed from the region of the contact and clamping point K or can be inserted into it (see also FIG. 2a).

In this case, the pivoting lever 15 is designed such that it can be used to exert pressure onto the pressing element 14 by pivoting—with a tool or directly by hand—to move the pressing element 14 linearly or substantially linearly in the actuation channel 12. Pressure can thus be exerted on the clamping leg 7 in a simple manner by pivoting the pivoting lever 15 over the pressing element 14 as an intermediate element to pivot the clamping leg 7 and to open the clamping point.

Advantageously, through this arrangement, the clamping leg 7 can be locked in an open position. This “locking position” R is characterised by the fact that the free end of the clamping leg 7 lies releasably locked in it at a distance from the busbar 5 in such a way that a conductor end can be inserted into the region of the clamping point K with as little resistance as possible. The locking position is depicted in FIG. 2a.

Alternatively, the locking position can be achieved by locking the pressing element 14 in a position in which the clamping leg 7 acts on the end of the pressing element 14 via manual or tool-supported action on the pivoting lever 15—that is to say by pivoting the same
so that the clamping leg 7 is pressed down (FIG. 1a). In contrast, as shown in FIG. 2a, the clamping leg 7 is locked on a locking spring 4, which is further explained below.

If the pressing element 14 and the actuation channel 12 have corresponding locking edges 16, 17 on their sides facing one another, the pressing element 14 of FIG. 1a is pressed by the clamping spring 4 slightly to the side in relation to the conductor insertion direction X into a locking position at the moment when the two locking edges 16, 17 are moved axially past one another.

It could also be envisaged that the two corresponding locking edges 16, 17 are not provided in the housing 1 and on the pressing element 14, but rather at a different point, for example between the pressing element 14 and the busbar 5 (not depicted).

It is thus envisaged according to FIGS. 1a-1c that the pressing element 14 is locked in a predetermined axial position in the actuation channel 12 on an abutment, such as in the housing 1 or on the busbar section 3, so that the clamping spring 4 or clamping leg 7 is in an open position and, due to locking the pressing element 14 in the housing 1 or on another element, is also in a locking position in which a free conductor end can be inserted into the conductor insertion channel 11. Thus when the clamping leg 7 is released from its locking position, the clamping leg 7 presses the conductor end resiliently against the busbar 5. The busbar 5 can be bent to form a clamping cage, such as in an L or U shape, so that a plug-in opening for the conductor is formed in the clamping cage. This is the case in the two designs from FIGS. 1 and 2. To create the locking state, the pressing element 14 also acts on the clamping leg 7 which is locked indirectly in the locking state via locking the pressing element 14.

The locking position R according to FIGS. 1c and 2a can be released again by at least one releasing mechanism in the conductor insertion channel in the conductor insertion direction X behind the clamping point K. This releasing mechanism 18 can have a pivoting element, such as a pivoting lever, one arm of which is arranged in the conductor insertion channel 11 in the conductor insertion direction “behind” or “below” the clamping point K.

The other arm is designed to pivot the pressing element 14 back from the locking position when the releasing mechanism 18 is pivoted by the action of the conductor to release the pressing element. The pressing element can then extend for a corresponding length in the actuation channel 12 to behind the clamping point—and the clamping leg 7 can relax and contact the inserted conductor end.

In contrast, according to FIG. 2a, the locking spring 41, which is preferably provided in one piece with the clamping spring 4, is formed on the clamping spring 7. This can have a locking leg 42 which can be locked onto the clamping leg 7, for example onto a recess in the clamping leg 7 remote from the clamping edge of the clamping leg 7. Thus, after the locking leg 7 is pivoted away from the busbar 5 into a locking position on the locking leg 42, the clamping spring 4 is also in an open locking state or can be locked. The locking spring 41 also advantageously has an actuation section 43 that protrudes into the conductor insertion channel 11 substantially at right angles to the conductor insertion direction (FIG. 2a). If a conductor is inserted, the clamping spring 4 can be released. However, there is then only one releasing mechanism, which is formed by the actuation section 43 on the locking spring 41 (whereby the conductor is used for releasing). With the pressing element 14, however, the locking state is also restored by pressing on the clamping leg 7. This functionality is therefore common to the connection terminals of FIGS. 1a and 2a.

The connection terminals 2 in FIGS. 1a and 2a operate simply and securely. The actuating device consists of two elements, such as the pivoting element 15, in particular the pivoting lever, and the pressing element 14. The actuating characteristic can be changed in comparison with actuation only via a pressing element 14.

Thus, the pivoting element 15 can have lever arms 15a, 15b of the same length or different lengths.

The lever arm 15a of the pivoting element 15 serves as an actuating arm that can pivot the pivoting element 15 when actuated manually or with a tool. The lever arm 15b serves to press down the pressing element 14. This is usually configured to be shorter than the longer, actuating lever arm 15a.

The length of the actuating arm 15a has a decisive effect on the magnitude of the force that must be applied to press down the pressing element 14 and to open the clamping leg 7 and move it back into the locking position.

In this regard, the actuating arm 15a can be configured to be shorter or longer, for example to allow manual actuation or actuation with a tool, such as a screwdriver.

In addition, the direction from which the actuation takes place can also vary with the pivoting element 15.

It can further be envisaged that the actuating lever is located substantially within the actuation channel 12 (see FIG. 1a) and protrudes only slightly beyond the edge of the terminal block or plug-in connector.

The pivoting element 15 can thus be rotatably mounted in the housing 1 according to one variant (e.g. FIGS. 1a and 2a).

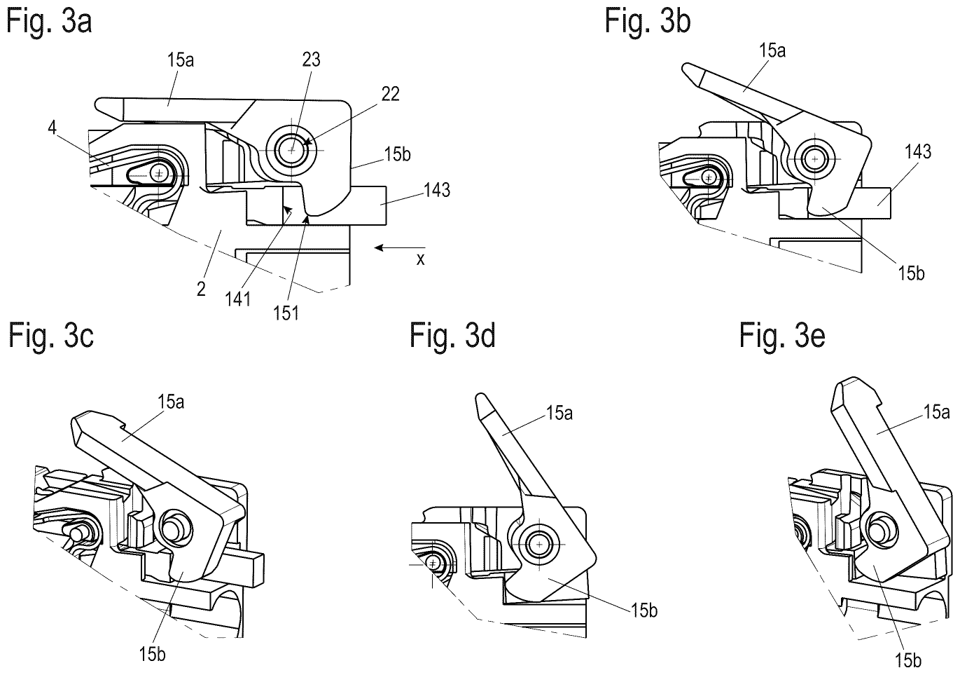

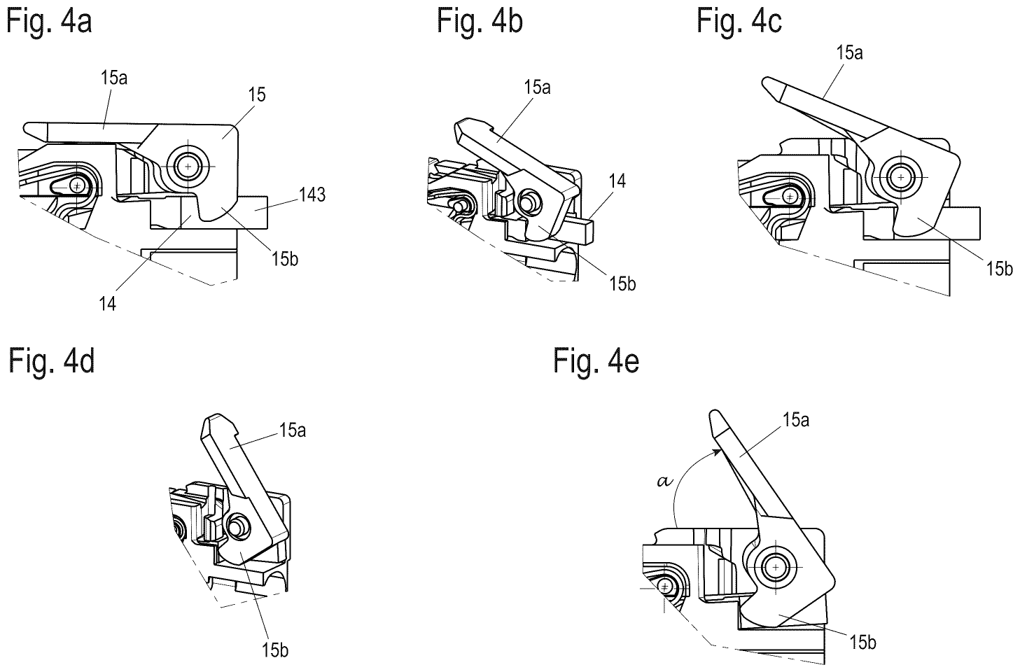

For this purpose, the pivoting element 15 can have journals which engage rotatably in recesses or eyes of the housing 1 (not depicted). Alternatively, the pivoting element 15 can have a recess 22, in which a journal 23 of the housing 1 rotatably engages (FIGS. 3a-3e, FIGS. 4a-4e), so that a fixed pivot bearing with a fixed axis of rotation is formed.

Alternatively, it is conceivable that the pivot bearing does not have a fixed axis of rotation (not depicted).

The pivoting element 15 at the outer circumference, such as the free end of the pressing arm 15b, could rest on the upper end of the pressing element 14 or a pressing surface 141 (FIG. 3a) at the end of the pressing element 14 and roll on this with a pressing contour 151. The pressing contour 151 (FIG. 3a) is preferably formed in such a way that the pressing element 14 is pressed in the conductor insertion direction X, or “downwards”, when the pivoting element 15 is pivoted out (see FIGS. 3a-3e and FIGS. 4a-4e).

The pressing element 14 can therefore be pressed down by actuating the pivoting element 15 to open the clamping spring 4 and to re-establish a locking state R. When the pressing element 14 is unlocked, the clamping leg 7 is freed and moves the pressing element 14 upwards, which in turn moves the pivoting element 15 back (unless it has already been pivoted back manually).

Coupling between the pivoting element 15 and the pressing element 14 can thus be formed simply and securely. Alternative configurations of this coupling are also conceivable.

Optionally, the pivoting lever 15 or the pressing element 14 also visually indicates, by the adopted position, whether the respective connection terminal is in an open locking position or in a clamping position.

For visual indication of the switching state, the pressing element 14 can protrude from the housing 1 at the top by a free end 143 in at least one switching state (see FIGS. 3a-3e and 4a-4e).

A projection, which forms the free end 143, is provided to the side of the pressing contour and the bearing surface. The locking state of this element on the housing and thus also the locking state R of the clamping spring 4 can be released via the end 143 by pivoting the pressing element 14 (or, for example, by a screwdriver which should be placed into the opening 12).

To prevent a user, such as an electrician or electronics technician, from pivoting the pivoting lever too far beyond the locking position R (FIGS. 3a-3e, 4a-4e and 5a-5d), wherein the pivoting lever itself or other elements could be damaged, a stop can be formed on the pivoting lever. After covering a predetermined pivoting angle alpha (FIG. 4e), starting from an initial position, the pivoting lever generally comes into contact externally with the actuating arm 15a on the housing 2 in a stop position A against a corresponding counter-stop so that the pivoting lever is stopped in a stop position. The pivoting angle alpha can be 60°-90° (see FIG. 4a as an example), which is advantageous for realizing defined movements of the pivoting lever 15. This, however, is not mandatory.

In a preferred configuration, the stop and the counter-stop are formed as corresponding stop and counter-stop surfaces 142, 152, which are parallel or substantially parallel to each other in the stop position after covering the predetermined angle (see in particular FIGS. 5c and 5d).

According to a further configuration, when the pivoting lever is in the stop position it is also releasably locked onto the element which has the counter-stop 142. Corresponding locking mechanism and counter-locking mechanism such as small projections and recesses can thus be provided on the pivoting lever and the stop element and/or clamping mechanism and counter-clamping mechanism such as journals and recesses can be formed.

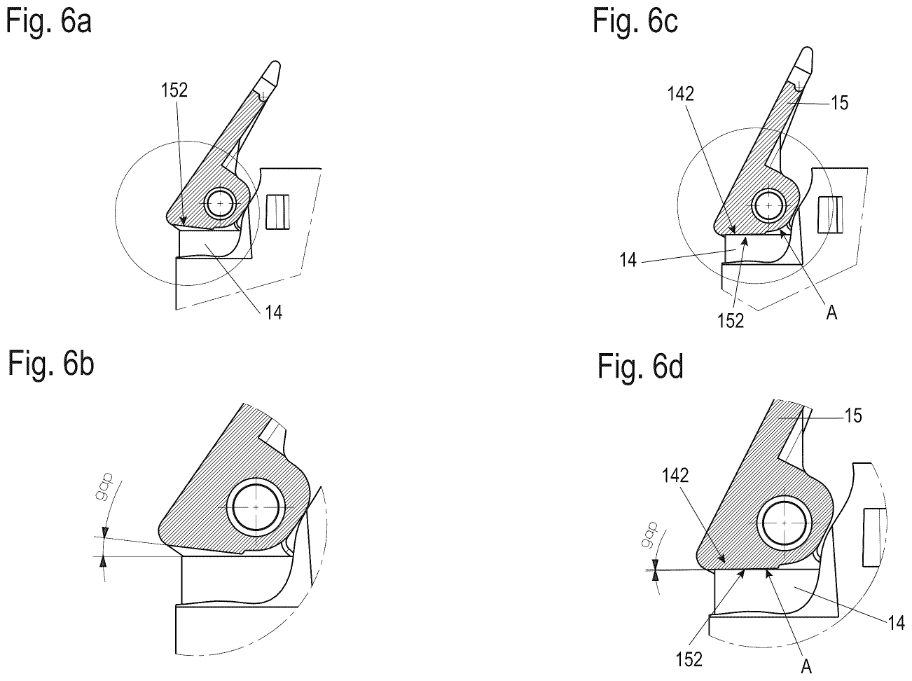

The element which has the counter-stop 142 can be the pressing element 14 (FIGS. 1 to 6).

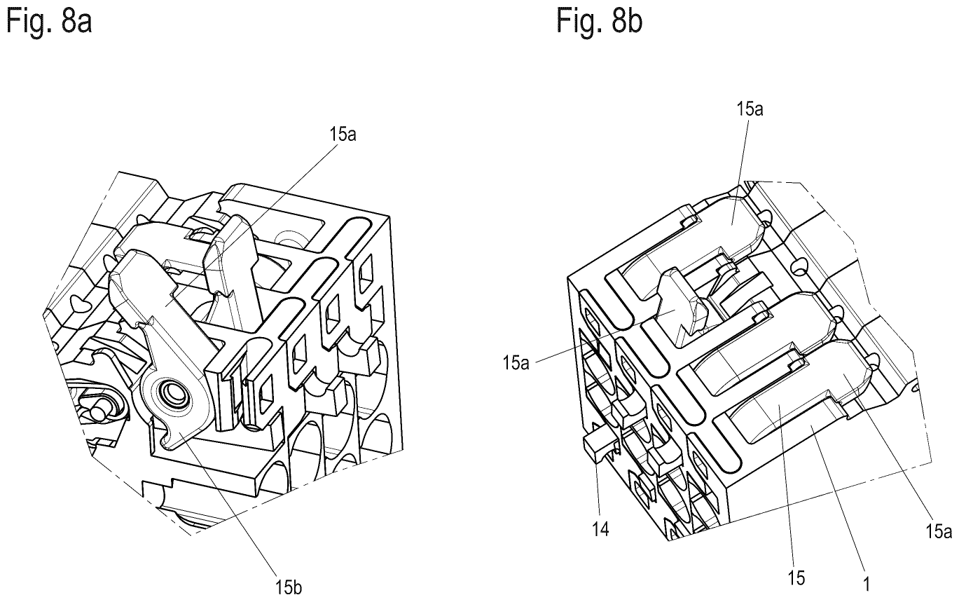

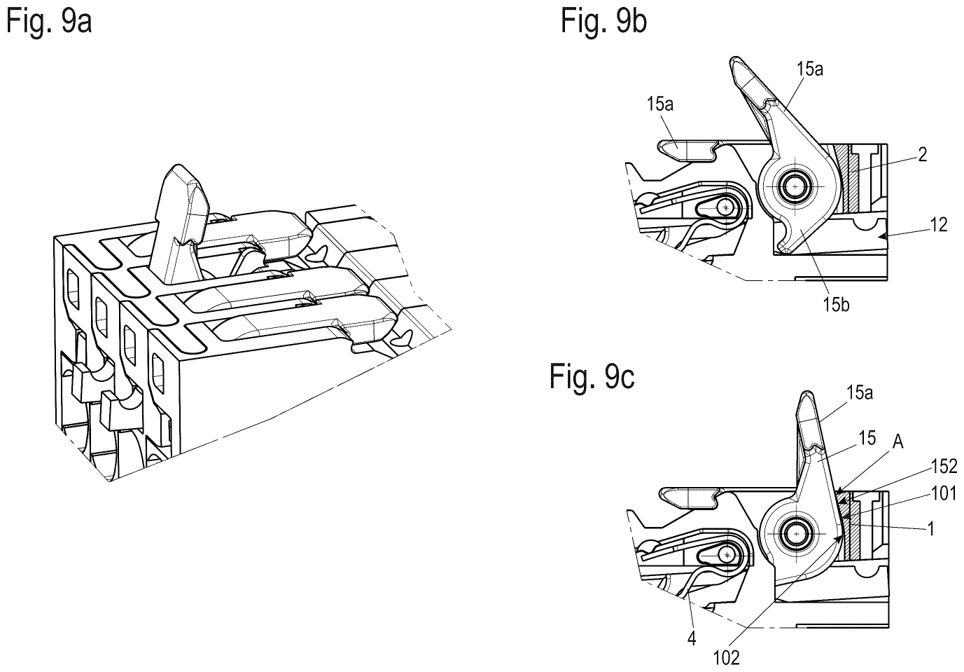

The element which has the counter-stop 101 can also be the housing 2 (FIGS. 7a to 9c). The stop surface 152 can be formed on any of the two lever arms 15a, 15b. According to FIGS. 1a to 6d, it is formed on the actuation arm 15a and according to FIGS. 7a to 9c, it is formed on the pressing arm 15b.

The stop position A is preferably only reached when the pressing element 14 has reached the locking position R of the clamping spring and its own accompanying locking position on the housing 2 and is locked there. In this manner, the locking functionality for locking the clamping spring 4 in an open position is fully maintained so that fine stranded wires are protected from being incorrectly inserted. This is because, even in the stop position A, a stranded wire can still be inserted into the opened clamping spring 4 and the clamping spring can be released indirectly through locking the clamping leg 7 by locking the pressing element 14 in the housing. The stop position A is no impediment here, as it serves to prevent damage.

It is even still possible to pivot the pivoting lever 15 back from the stop position A onto the housing 2. This does not release the locking position.

Preferably, the plug-in connector may also have, for each connection terminal, a plug-in terminal 24 for contacting a mating connector, such as on the side facing away from the connection terminal 2 (see FIG. 1a).

The plug-in connectors, as well as the terminal blocks, can have a rear wall 26, which forms a rear wall 26 of the housing 1. From the other side, recesses 27 are formed in the housing 1 as mounting contours so that the structural parts can be mounted from the other side (see FIG. 1a).

The connection terminals being formed as connections of terminal blocks can also be strung together.

Furthermore, a cover plate can be placed onto the open side of a last plug-in connector of a row to protect the connection device inside this plug-in connector from external influences and to more safely prevent incorrectly plugging the conductor end.

Not all elements of the respective connection terminals are depicted in FIGS. 7a to 9c, but rather only some elements for producing the stop function. The connection terminals can be formed as in FIG. 1a or 2a, for example.

What is claimed is:

1. A connection terminal for connecting a conductor formed as a direct plug-in terminal, comprising a clamping spring arranged in a housing and having a resilient clamping leg being movable at least into an open position and a locking position and an actuating device for pressing down the resilient clamping leg into its open and locking positions for insertion of a conductor, the housing having a conductor insertion channel for inserting the conductor into a clamping point between a free end of the resilient clamping leg and a busbar, the actuation device having a pressing element and a pivoting element which interacts with the pressing element at least when the resilient clamping leg moves into the locking position, the pivoting element having a stop, at least one releasing mechanism being provided for releasing the resilient clamping leg from its locking position, the pivoting element being configured to act on the pressing element and the pressing element being configured to act on the resilient clamping leg, wherein when the pivoting element is pivoted after the resilient clamping leg is locked in the locking position, it can be moved into a stop position at the stop and a counter-stop.

2. The connection terminal according to claim 1, wherein the stop on the pivoting element and the counter-stop include corresponding stop and counter-stop surfaces oriented one of parallel and substantially parallel to each other in the stop position after covering a predetermined angle.

3. The connection terminal according to claim 1, wherein the pivoting element is arranged in an actuation channel in front of the pressing element in a conductor insertion direction.

4. The connection terminal according to claim 2, wherein the pivoting element includes a pivoting lever pivotably mounted in or on the housing having a pressing arm to act on a corresponding pressing surface of the pressing element via a pressing contour and having an actuating arm configured for manual actuation of the pivoting lever.

5. The connection terminal according to claim 4, wherein the stop surface of the pivoting element is provided on the pressing arm of the pivoting element.

6. The connection terminal according to claim 4, wherein the stop surface of the pivoting element is provided on the actuating arm of the pivoting element.

7. The connection terminal according to claim 2, wherein the stop surface is arranged on the pressing element.

8. The connection terminal according to claim 2, wherein the stop surface is arranged on the housing.

9. The connection terminal according to claim 1, wherein the pressing element is one of linearly and substantially linearly movable in a housing actuation channel running parallel to the conductor insertion channel or in an inclined manner at an angle of up to ±90° to the conductor insertion channel.

10. The connection terminal according to claim 1, wherein a locking spring for locking the clamping spring in an open locking state is arranged on the clamping spring.

11. The connection terminal according to claim 1, wherein the pressing element is lockable in a locking position in which it holds the clamping leg in its open position for insertion of the conductor.

12. The connection terminal according to claim 1, wherein the pivoting element acts on the pressing element to release the locking position.

13. The connection terminal according to claim 3, wherein the pivoting element is arranged one of completely and partially in the actuation channel.

14. The connection terminal according to claim 1, wherein the pivoting element is pivotably mounted on the housing.

15. The connection terminal according to claim 1, wherein the pivoting element is pivotably mounted on the housing via a pivot bearing having a fixed axis of rotation.

16. The connection terminal according to claim 4, wherein the pressing arm rests freely on the actuating element for displacement of the pressing element via the pivoting lever, the pressing element configured to act on the clamping leg to one of press the clamping spring alone and press the clamping spring and pressing element jointly into an open and locking position.

17. The connection terminal according to claim 1, wherein one of the pivoting element and the pressing element are an optical indication element configured to see whether the clamping leg is in the open state or a clamping state.

18. The connection terminal according to claim 1, wherein the conductor acts on a first releasing mechanism for releasing the locking position of the clamping spring when the conductor is inserted into the conductor insertion channel.

19. The connection terminal according to claim 18, wherein the pressing element includes a further releasing mechanism for releasing the locking position of the clamping spring.

20. A terminal block having one or more connection terminals according to claim 1.

21. One of a plug-in connector and printed circuit board terminal including one or more connection terminals according to claim 1.

22. The plug-in connector or printed circuit board terminal according to claim 21, having a disc-like design.
